(19) United States
(12) Patent Application Publication
(10) Pub. No.: US 2025/0006020 A1
(43) Pub. Date: Jan. 2, 2025

(54) TRAFFIC MANAGEMENT OF PASSENGERS AND PREDICTING PASSENGER SEAT OCCUPANCY

(71) Applicant: Siemens Mobility GmbH, München (DE)

(72) Inventors: Andreas Winzen, Nürnberg (DE); Andreas Grzona, Straelen (DE); Jens Cuylen, Wuppertal (DE); Andreas Häussler, Solingen (DE); Markus Wilhelm, Mönchengladbach (DE)

(21) Appl. No.: 18/689,520

(22) PCT Filed: Aug. 17, 2022
(86) PCT No.: PCT/EP2022/072903

§ 371 Date: Mar. 6, 2024

(30) Foreign Application Priority Data
Sep. 6, 2021 (DE) 10 2021 209 813.4

(51) Int. Cl. G08B 7/06; B60N 2/00; G01C 21/20

(52) U.S. Cl. CPC G08B 7/066; B60N 2/002; G01C 21/206

(57) ABSTRACT

A method for predicting an occupancy state of a passenger seat and for traffic management of passengers, includes determining an actual occupancy state of the passenger seat by using sensors, acquiring information associated with the future occupancy state of the passenger seat, determining prediction data relating to a future occupancy state of the passenger seat on the basis of the actual occupancy state and the associated information by using a data processing apparatus, and outputting the prediction data to passengers by using an output apparatus. A route guidance for passengers is determined on the basis of the prediction data, and the route guidance is output to passengers by using an output apparatus. A system for carrying out the method is also provided.

The invention relates to a method for predicting a future state of occupancy of a passenger seat, to a system for carrying out the method, and to a computer program product.

At public transport stops, passenger flows of boarding and alighting passengers meet. Situations frequently occur in which the respective passenger flows impede one another in their flow. One reason is, for example, an uneven distribution of alighting passengers or boarding passengers between the entrances and exits which are present. A further reason can be seen in the fact that boarding passengers do not know which sections of the vehicle have free passenger seats available. Thus, it can happen that boarding passengers board in sections of the vehicle in which no or only a small number of passenger seats are free. Some of the passengers then go in search of free passenger seats in the vehicle. This in turn can have the result that multiple passengers looking for free passenger seats meet and, owing to the confined conditions in a vehicle, congestion is possibly caused. Hitherto, it has been possible to determine an occupancy of a vehicle or of a section of the vehicle by means of sensors. For example, camera systems, weight measurements of the part of the vehicle in question by means of pressure sensors or an evaluation of passenger counting devices are used here. It is additionally possible to make use of observations of the operating personnel in order to determine the occupancy. However, it is not possible to determine passenger seats which are to become free at a future stop solely on the basis of the knowledge of a distribution of free passenger seats.

The object of the invention is to reduce the number of encounters between passengers and in this manner to achieve an improved operating procedure.

This object is achieved by a method having the features of claim 1.

A further object of the invention is to provide a system for carrying out the method according to the invention.

This object is achieved by a system having the features of the further independent system claim.

In addition, the object of the invention is to provide a computer program for carrying out the method according to the invention with the system according to the invention.

This object is achieved by a computer program having the features of the further independent computer program claim.

Advantageous developments of the present invention can be found in each case in the dependent sub-claims.

The method according to the invention for predicting a future state of occupancy of a passenger seat is in particular a computer-implemented method. For predicting the future state of occupancy of the passenger seat, the method according to the invention has the following steps: (i) determining an actual state of occupancy of the passenger seat by means of sensors; (ii) acquiring information associated with the future state of occupancy of the passenger seat; (iii) determining prediction data relating to the future state of occupancy of the passenger seat on the basis of the actual state of occupancy and the associated information by means of a data processing apparatus; and (iv) outputting the prediction data to passengers by means of an output apparatus. In this manner, an efficient and reliable prediction can be made about passenger seats that are to become free. On the basis of the prediction data, boarding passengers can easily be informed about passenger seats that are free and/or that are to become free. Determination of an actual state of occupancy of the passenger seat by means of sensors can be carried out, for example, by means of an optical sensor apparatus, such as a camera system or a light barrier, and/or by means of an electromechanical sensor apparatus, such as pressure sensors or proximity sensors, and/or by means of another sensor apparatus known to a person skilled in the art. The passenger seat is in particular the passenger seat of a vehicle. The vehicle is preferably in the form of a rail-borne passenger transport vehicle.

In an advantageous development, it is provided that the information associated with the future state of occupancy is acquired by the acquisition of passenger data associated with the passenger seat. These associated passenger data can be acquired, for example, by means of a ticket inspection or by means of an application on a terminal device of a passenger. In particular, the information associated with the future state of occupancy is acquired by the acquisition of reservation data associated with the passenger seat. The future state of occupancy can easily be acquired for reserved passenger seats on the basis of the reservation data. Furthermore, the associated passenger data can be, for example, information about a travel destination, connections which have hitherto been made, a connection type, such as, for example, a flexibly selectable travel connection or a route-related or journey-time-related connection of a passenger who is occupying the passenger seat in question. This allows a future state of occupancy to be determined in a simple manner for a passenger seat for which no reservation data are available.

A further advantageous development provides that a future state of occupancy of the passenger seat is determined for a predetermined location and/or for a predetermined time on the basis of the actual state of occupancy and the associated information. In this manner, a future state of occupancy of the passenger seat can reliably be predicted even before the vehicle arrives at a stop.

In a further advantageous development, it is proposed that the future state of occupancy of the passenger seat for a predetermined stop of the vehicle is outputted to passengers outside and/or inside the vehicle by means of the output apparatus. This allows information to be transmitted both to boarding passengers and to passengers who are already in the vehicle and are searching for a free passenger seat.

An advantageous development further provides a method for traffic management of passengers on the basis of the prediction data. In this method, the prediction data are determined as described hereinbefore. In addition, these prediction data are determined in the manner described hereinbefore for a plurality of passenger seats in the vehicle. A route guidance for passengers is then determined on the basis of the prediction data. This route guidance is then outputted to the passengers by means of an output apparatus. This allows a time-efficient alighting and boarding operation of passengers at a stop to be achieved. By means of the route guidance, alighting passengers, for example, can be evenly distributed between exits. Alternatively or in addition, alighting passengers can be divided into groups, for example, which are distributed between different exits. This allows the passengers to alight quickly and smoothly. Furthermore, even before the vehicle arrives, boarding passengers can be directed by means of the route guidance to boarding points which lead to a section of the vehicle in which there are free passenger seats. It is further conceivable that passenger flows are separated from one another by means of the route guidance in such a manner that the number of encounters between the passengers is minimized. In this manner, a pandemic situation, for example, can be taken into consideration in the route guidance. Furthermore, this can make it possible for groups of boarding and alighting passengers to be separated from one another in the route guidance starting from outside doors and toward outside doors of the vehicle.

In an advantageous embodiment variant, it is proposed that the route guidance is outputted to a mobile terminal device of a passenger. It is conceivable here that the route guidance is outputted to each passenger in such a manner that it is personalized in dependence on the travel data of the passenger. By taking connection information, for example, of the passenger into consideration in the route guidance, the passenger can be directed by means of his terminal device to a passenger seat which is available to him until his next planned exit. The terminal device can be, for example, a smartphone, a tablet, a laptop or another terminal device which can be connected to the internet or to a network made available within the vehicle. In particular, the terminal device is a mobile terminal device.

A further advantageous development provides that a number and a position of passenger seats in the vehicle that are to become free are determined on the basis of the prediction data. Furthermore, it is provided that at least part of the route guidance is determined in dependence on the number and the position of the passenger seats that are to become free. In this manner, time efficiency of the transfer operation can be improved considerably. Delays due to an unevenly distributed number of passengers at entrances or exits or due to passengers searching for passenger seats can thus be prevented.

An advantageous embodiment variant provides that a uniform traffic direction is specified in at least one zone along the vehicle on the basis of the route guidance. This traffic direction is preferably a traffic direction directed in or against an intended direction of travel of the vehicle. This makes it possible for passengers to be directed clearly and efficiently.

In a further advantageous embodiment variant, it is provided that boarding passengers are directed to free passenger seats by means of the outputting of the route guidance. Free passenger seats can thus be located easily and quickly by the passengers. Even before the vehicle arrives at a stop, boarding passengers can thus be guided to entrances from which free passenger seats can quickly be reached. In addition, the number of encounters between boarding passengers and alighting passengers can thus be reduced.

An advantageous embodiment variant further provides that a duration of the outputting of the route guidance to a section of the vehicle having a plurality of free passenger seats is chosen in dependence on the number of free passenger seats in that section. In the case where a large number of free passenger seats has been determined in a section of the vehicle, a duration of the outputting of the route guidance to that section is thus chosen to be correspondingly long. If, on the other hand, it is determined that there are only a small number of free passenger seats in a section of the vehicle, a duration of the outputting of the route guidance to that section of the vehicle is chosen to be correspondingly short. This allows boarding passengers to easily be directed to sections of the vehicle that are not heavily occupied.

An alternative embodiment variant further provides that alighting passengers are directed from a predetermined zone of the vehicle to predetermined doors of the vehicle on the basis of the route guidance. An uneven distribution of alighting passengers between different exits can be prevented. In addition, groups of passengers, for example, can be divided between different exits which are separate from one another. This allows a rapid alighting operation to be achieved. Furthermore, the risk of congestion at exits can thus be minimized.

The method according to the invention can be carried out by means of the system according to the invention.

The system according to the invention has at least one memory. The at least one memory can be, for example, a memory of a computer or of a server. The at least one memory can further be an optical, magnetic, solid-state and/or non-volatile memory. The system according to the invention additionally has a sensor apparatus. An actual state of occupancy of at least one passenger seat of a vehicle can be determined by means of the sensor apparatus. Preferably, the actual state of occupancy of a plurality of passenger seats of the vehicle can be determined by means of the sensor apparatus. The actual state of occupancy can be stored in the at least one memory. The mentioned sensor apparatus is in particular the sensor apparatus which has already been described in connection with the method. An information acquisition device is further provided. Information associated with the state of occupancy of the at least one passenger seat can be determined by means of the information acquisition device. This associated information can be stored in the at least one memory. The information acquisition device can be, for example, an application on a terminal device of a passenger or of a ticket inspector. The information acquisition device can further be a reservation system. This reservation system can be, for example, a server or a computer by means of which reservation data are acquired and stored. A data processing apparatus is additionally provided. This data processing apparatus is adapted to determine prediction data relating to a future state of occupancy of the passenger seat on the basis of the actual state of occupancy and the associated information. The data processing apparatus can be, for example, a microprocessor, a computer, a server or a further apparatus known to a person skilled in the art for the processing of data. The data processing apparatus is additionally adapted to carry out a computer program. The data processing apparatus is preferably adapted to receive, process and output data. The data processing apparatus can further be adapted to read out a memory and/or to store data in a memory. It is additionally conceivable that the data processing apparatus is a central data processing apparatus. Such a central data processing apparatus can be in the form of a server or in the form of a computer. It is further conceivable that the central data processing apparatus can be accessed via the internet or a dedicated data link. An output apparatus is additionally provided, which has a link with the data processing apparatus or the at least one memory for the transmission of data. The method according to the invention can be carried out efficiently by means of the described system.

In an advantageous development, it is provided that the data processing apparatus is adapted to determine a route guidance for passengers on the basis of the prediction data. In this manner, the route guidance can be calculated at short notice and quickly.

In a further advantageous development, it is proposed that the output apparatus is adapted to output the prediction data and/or the route guidance visually, haptically or acoustically. This permits reliable and barrier-free traffic management of boarding and alighting passengers. The output apparatus can have a loudspeaker, a visual display, a haptic display or any desired combination thereof. By way of example, the output apparatus can be arranged along a section of a walkway on the floor, along a section of a luggage rack, along a roof region or on furnishings of the vehicle. It is further conceivable that the output apparatus has monitors, in particular already existing passenger information monitors. It is additionally conceivable to provide traveling lights as part of the output apparatus. A traveling light can be implemented, for example, by means of an LED strip having a plurality of LEDs arranged side by side. The individual LEDs are illuminated in succession in such a manner that an observer has the impression of an advancing point of light or strip of light. It is further conceivable that mobile terminal devices of passengers are provided as part of the output apparatus. For example, the prediction data and/or the route guidance can thus be outputted visually, haptically and/or acoustically according to individual requirements. This allows the prediction data and/or the route guidance to be outputted for passengers in a barrier-free manner. In particular, the route guidance can be outputted individually via headphones of a passenger which are connected to the mobile terminal device.

An advantageous development further provides that the output apparatus has at least one traffic direction display by means of which a traffic direction specified by the route guidance can be displayed. In this manner, traffic management can be adapted easily and efficiently. In addition, this allows the traffic management to be adapted at short notice to changing prediction data. To this end, arrows can be provided, for example, which illuminate according to the specified traffic direction. It is additionally conceivable that the arrows are provided with different colors in dependence on the specified traffic direction. For example, red symbols can signal that entry to a section of a carriage is prohibited. It is further conceivable that the traffic direction can be specified by outputting or displaying conventional traffic signs. For example, before a specified traffic direction is changed, colored warning symbols can indicate the impending change. In particular, a yellow warning symbol can be provided to warn of a change to the traffic direction.

By means of the computer program according to the invention for predicting a state of occupancy of a passenger seat, the system according to the invention is caused to carry out the method described above for predicting a state of occupancy. Furthermore, by means of the computer program for traffic management of passengers, the system according to the invention is caused to carry out the above-described method for the traffic management of passengers.

The computer program can in particular be in the form of a computer-readable medium, for example in the form of a data carrier. One or more computer programs for carrying out the method according to the invention can be stored on the data carrier. The computer-readable medium is preferably a data carrier, such as a CD, a DVD or a flash memory. This permits simple handling or commercial distribution of the computer program. Alternatively or in addition, the computer program can also be in the form of one or more data files on a storage medium, in particular on a server. The computer program can optionally be retrievable or executable via a data link. For example, the computer program can be retrievable or executable by download via the internet or a dedicated data link.

The above-described properties, features and advantages of the invention as well as the manner in which they are achieved are explained in greater detail in conjunction with the figures in the following description of the exemplary embodiment of the invention. Where expedient, the same reference signs are used in the figures for the same or mutually corresponding elements of the invention. The exemplary embodiment serves to explain the invention and does not limit the invention to the combinations of features indicated therein, also not in relation to functional features. In addition, all the features indicated in the exemplary embodiment can be combined in isolation and in a suitable manner with the features of any desired claim.

In the figures:

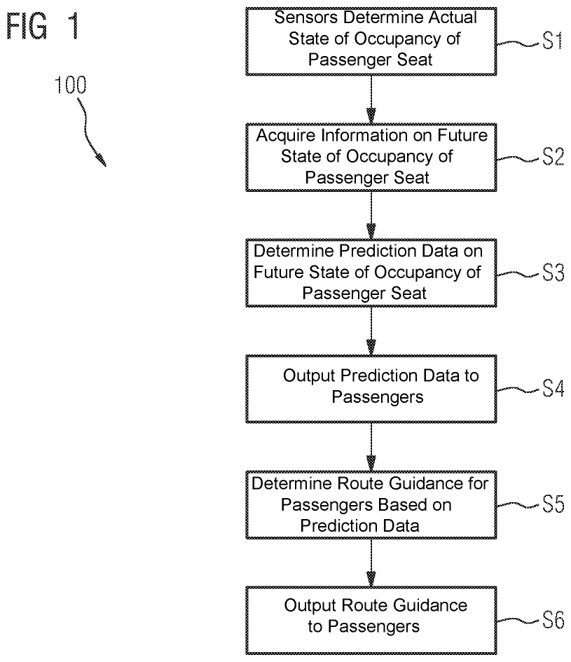

FIG. 1 shows an illustration of an exemplary embodiment of a method according to the invention;

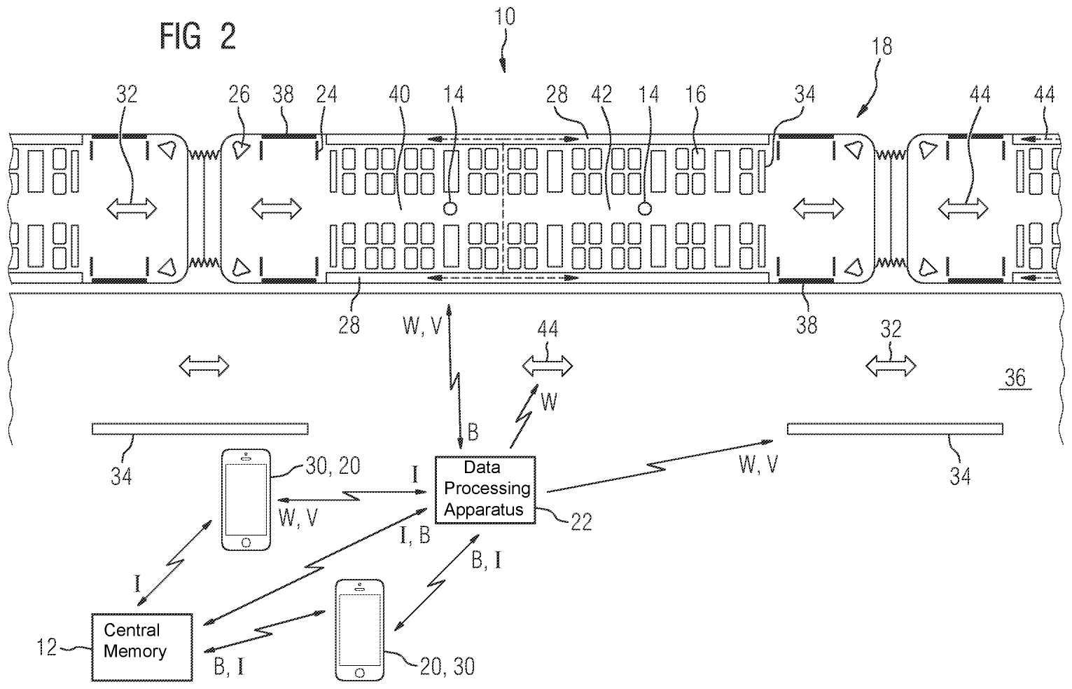

FIG. 2 shows a schematic representation of an example of a system according to the invention and a further illustration of the method according to the invention.

FIG. 1 illustrates an exemplary embodiment of a computer-implemented method 100 for predicting a state of occupancy of a passenger seat 16 and for traffic management of passengers on the basis of the prediction of the state of occupancy. The method 100 has by way of example six steps S1, S2, S3, S4, S5, S6. In a first step S1, an actual state of occupancy B of the passenger seat 16 is determined by means of sensors. Then, in a second step S2, information I associated with a future state of occupancy of the passenger seat 16 is acquired. Steps S1 and S2 can be carried out in any order. In a third step S3, prediction data V relating to a future state of occupancy of the passenger seat 16 are determined by means of a data processing apparatus 22 on the basis of the actual state of occupancy B and the associated information I. These prediction data V are outputted to passengers in a fourth step S4 by means of, for example, monitors 34 or an application on a mobile terminal device 30. In a fifth step S5, a route guidance W for passengers is determined on the basis of the prediction data V. Finally, in a sixth step S6, the route guidance W is outputted to passengers by means of, for example, a large number of different visual, acoustic and/or haptic output apparatuses 24, 26, 28, 30, 32, 34.

FIG. 2 shows, in a schematic representation, a system 10 for carrying out the method 100. FIG. 2 additionally illustrates by way of example the method 100 described in connection with FIG. 1. In order to illustrate the present exemplary embodiment, FIG. 2 shows a section of a vehicle 18, which is in the form of a rail-borne passenger transport vehicle having a plurality of carriages. In the present exemplary embodiment, this vehicle 18 is shown at a stop having a platform 36. For the purposes of informing passengers, the system 10 has, for example, haptic output apparatuses 24, loudspeakers 26, traveling lights 28, mobile terminal devices 30, visual displays 32 and monitors 34. In the present exemplary embodiment, monitors 34 and visual displays 32 are arranged on the platform 36. Further monitors 34 and visual displays 32 are additionally arranged in the passenger compartment of the vehicle 18. There are further arranged in the vehicle 18, for example, haptic output apparatuses 24, loudspeakers 26 and traveling lights 28. The haptic output apparatuses 24 are arranged in an access region on doors 38 of the vehicle 18. In addition, traveling lights 28 are arranged along a side wall of the passenger compartment, shown by way of example, of the vehicle 18. These traveling lights 28 can be in the form of one or more LED strips, which have LEDs arranged side by side. A plurality of LEDs can here be activated in succession in such a manner that the observer has the impression of a traveling strip of light. In this manner, a traffic direction 44 for passengers can be specified. The traveling lights 28 can be arranged in a readily visible manner on luggage racks (not shown in detail), in the floor region or in the roof region of the passenger compartment. Furthermore, the visual displays 32 are arranged by way of example in a walkway region both of the platform 36 and of the passenger compartment of the vehicle 18. In the present exemplary embodiment, the visual displays 32 are in the form of a double arrow. For the purposes of specifying a traffic direction 44, each arrow direction of the double arrow can be illuminated independently of the other arrow direction. It is further conceivable that each arrow direction can be illuminated in different colors, so that a traffic direction 44 can be clearly specified to passengers. Furthermore, the monitors 34 which are arranged inside the vehicle 18 can be passenger information monitors which are already present.

The system 10 is further adapted to determine an actual state of occupancy B of the passenger seats 16. To this end, the system 10 has a sensor apparatus 14. In the present exemplary embodiment, the sensor apparatus 14 is a camera system which acquires the actual state of occupancy B of the passenger seats 16 inside the vehicle 18 in a manner known to a person skilled in the art. Alternatively or in addition, it is conceivable that the sensor apparatus 14 has pressure sensors or light barriers by means of which the actual state of occupancy B of the passenger seats 16 is acquired.

Alternatively or in addition, it is conceivable that the actual state of occupancy B is acquired within the context of a ticket inspection.

FIG. 2 additionally illustrates the acquisition of information which is associated with a future state of occupancy of the passenger seats 16. To this end, the system 10 has an information acquisition device 20. In the present exemplary embodiment, the information acquisition device has on the one hand a reservation system (not shown in detail). The reservation system is adapted to acquire reservation data in the form of passenger data associated with a passenger seat 16. In addition, information I associated with a passenger seat 16 is acquired in that a ticket inspection is carried out. Within the context of the ticket inspection, information, such as, for example, travel data of a passenger, such as destination, transfer destination or connection type as well as connections previously made, is acquired and associated with the corresponding passenger seat 16 occupied by the passenger. For this purpose, the information acquisition device 20 in the present exemplary embodiment has an application which can be used on a mobile terminal device 30. This application is adapted to acquire the above-mentioned passenger data and associate them with a passenger seat 16. The mobile terminal device 30 can be, for example, a mobile terminal device 30 of a ticket inspector for the purposes of ticket inspection or a mobile terminal device 30 of a passenger with a corresponding application. Mobile terminal devices 30 can be, for example, smartphones, tablets or laptops. The mobile terminal device 30 can expediently be connected to a data network, such as, for example, the internet.

The system 10 further has a central memory 12. The central memory 12 can be, for example, a memory of a server, of a computer or of a computer network. In the present exemplary embodiment, the information about the actual state of occupancy B and the associated information I in the form of the reservation data and the passenger data associated with the passenger seat 16 is stored on the central memory 12. The system 10 further has, for example, a data processing apparatus 22. The data processing apparatus 22 can be a microprocessor, a computer or a server. In the present exemplary embodiment, the data processing apparatus 22 is connected in a manner known to a person skilled in the art to the central memory 12 for the exchange of data. By means of the data management apparatus 22, prediction data V relating to a future state of occupancy of a passenger seat 16 are determined on the basis of the actual state of occupancy B of the passenger seat 16 and the information I associated with that passenger seat 16. In the present exemplary embodiment, these prediction data V are determined for each passenger seat 16 of the vehicle 18. Passenger seats 16 that are to become free and free passenger seats can thus be determined even before the vehicle 18 arrives at a stop. In the present exemplary embodiment, outputting of the prediction data V by way of the monitors 34 on the platform is provided. In this manner, boarding passengers can receive an overview of which section of the vehicle 18 will have free passenger seats 16 even before the vehicle 18 arrives at the stop. The boarding passengers can thus distribute themselves between corresponding entrances beforehand. It is additionally conceivable that the prediction data V are outputted on mobile terminal devices 30 of the passengers. A passenger can thus be informed individually and in a mobile manner of free passenger seats 16 in the vehicle 18 even before he boards or makes a transfer. It is further conceivable that the prediction data V are outputted via the monitors 34 in the vehicle 18. For reasons of clarity, transmission of data is illustrated schematically in FIG. 2 in the form of zigzag lines, for example. The individual components of the system 10 are expediently connected together in any desired manner known to a person skilled in the art for the purposes of data transfer. For example, a connection for the purposes of data transfer can be a data bus connection. This can be implemented in a wired manner, by radio or by a combination thereof.

The data processing apparatus 22 is additionally adapted to determine a route guidance W on the basis of the prediction data V. To this end, a number and a position of passenger seats 16 in the vehicle 18 that are free and that are to become free is determined in the present exemplary embodiment by means of the data processing apparatus 22. This number and position of passenger seats 16 that are free and that are to become free is determined for predetermined stops.

On the basis of the number and position of passenger seats 16 that are to become free, a route guidance W for alighting passengers, for example, is determined in such a manner that the alighting passengers are distributed in equal numbers between the closest doors 38. This is here achieved, for example, in that the passenger compartment of the vehicle 18 is divided into two zones 40, 42. The two zones 40, 42 are divided such that approximately the same number of passenger seats 16 become free in each of the zones 40, 42. Then, a uniform traffic direction 44 is specified for each zone 40, 42. This is achieved, for example, by means of the traveling lights 28. This is illustrated in FIG. 2 by means of arrows on the traveling lights 28. It is additionally conceivable that the alighting passengers are informed of the route guidance W individually via an application on their mobile terminal device 30. It is here additionally conceivable to output the route guidance W haptically to a passenger by means of the mobile terminal device 30. It is additionally conceivable that passengers are informed of the route guidance W acoustically by means of loudspeakers 26.

Furthermore, the route guidance W for boarding passengers is determined on the basis of the number and position of free passenger seats 16 before the vehicle 18 arrives at a stop. In this manner, passengers can be directed on the basis of the route guidance W and a specified traffic direction 44 to sections of the vehicle 18 in which free passenger seats 16 are available. For example, a duration of the visual display 32 can here be adapted to the number of free passenger seats 16 in a predetermined section of the vehicle in such a manner that a traffic direction 44 specified by the visual display 32 is displayed for longer in the direction of the predetermined section, the more free passenger seats 16 are available in that predetermined section of the vehicle 18.

It is further conceivable that the route guidance W is determined individually for an alighting passenger or a boarding passenger. This can be achieved, for example, in that the route guidance W is outputted by means of an application of a mobile terminal device 30 of the passenger in dependence on his travel data. In this manner, the passenger in question can be directed, for example, to a free passenger seat 16 which is available to him for the entire duration of his journey within the vehicle 18. Alternatively, an alighting passenger can be directed in dependence on his travel data to a next intermediate destination, such as, for example, to a platform to catch a connecting train or to a bus stop. It is further conceivable that the route guidance W is outputted by means of the haptic output apparatuses 24, by means of the loudspeakers 26 and by means of the monitors 34 inside the vehicle 18. It is additionally conceivable that the route guidance W for boarding passengers is outputted by means of the traveling lights 28. By means of the monitors 34, traffic signs or color-coded traffic direction signs for specifying the traffic direction 44 to the passengers inside the vehicle 18 can be specified. Passenger flows can thus be directed at short notice and in a situation-dependent manner. In addition, this makes it possible for encounters between passengers to be reduced. Furthermore, bottleneck situations can be avoided and as smooth an operating procedure as possible can be achieved.

Although the invention has been illustrated and described in detail by the preferred exemplary embodiment and the variations thereof, the invention is not limited by the disclosed examples and other variations can be derived therefrom by a person skilled in the art without departing from the scope of protection of the invention.

1-15. (canceled)

16. A method for predicting a future state of occupancy of a passenger seat, the method comprising:
determining an actual state of occupancy of the passenger seat by using sensors;
acquiring information associated with the future state of occupancy of the passenger seat;
determining prediction data relating to the future state of occupancy of the passenger seat based on the actual state of occupancy and the associated information by using a data processing apparatus; and
outputting the prediction data to passengers by using an output apparatus.

17. The method according to claim 16, which further comprises carrying out the step of acquiring the information associated with the future state of occupancy by acquiring passenger data associated with the passenger seat.

18. The method according to claim 17, which further comprises providing reservation data associated with the passenger seat as the passenger data.

19. The method according to claim 16, which further comprises:
determining the future state of occupancy of the passenger seat for at least one of a predetermined location or a predetermined time based on the actual state of occupancy and the associated information; and
outputting the future state of occupancy of the passenger seat of a vehicle for a predetermined stop of the vehicle to passengers at least one of outside or inside the vehicle by using the output apparatus.

20. A method for traffic management of passengers, the method comprising:
determining prediction data according to claim 16 for a plurality of passenger seats in the vehicle;
determining a route guidance for passengers based on the prediction data; and
outputting the route guidance to passengers by using an output apparatus.

21. The method according to claim 20, which further comprises:
determining a number and a position of passenger seats in the vehicle that are to become free based on the prediction data; and
determining at least part of the route guidance in dependence on the number and the position of the passenger seats that are to become free.

22. The method according to claim 20, which further comprises specifying a uniform traffic direction in at least one zone along the vehicle based on the route guidance.

23. The method according to claim 20, which further comprises directing alighting passengers from a predetermined zone of the vehicle to predetermined doors of the vehicle based on the route guidance.

24. The method according to claim 20, which further comprises:
determining a number and a position of free passenger seats in the vehicle based on the prediction data;
determining at least one further part of the route guidance in dependence on the number and the position of the free passenger seats; and
directing boarding passengers to free passenger seats by outputting the route guidance.

25. The method according to claim 24, which further comprises choosing a duration of outputting the route guidance to a section of the vehicle having a plurality of free passenger seats in dependence on the number of free passenger seats in that section.

26. A system for carrying out the method according to claim 16, the system comprising:
a sensor apparatus for determining an actual state of occupancy of at least one passenger seat of a vehicle;
an information acquisition device for determining information associated with a state of occupancy of the at least one passenger seat;
at least one memory for storing the actual state of occupancy and for storing the associated information;
a data processing apparatus adapted to determine prediction data relating to a future state of occupancy of the passenger seat based on the actual state of occupancy and the associated information; and
an output apparatus being linked with said data processing apparatus or said at least one memory for a transmission of data.

27. The system according to claim 26, wherein said data processing apparatus is adapted to determine a route guidance for passengers based on the prediction data.

28. The system according to claim 26, wherein said output apparatus is adapted to output at least one of the prediction data or the route guidance at least one of visually, haptically or acoustically.

29. The system according to claim 26, wherein said output apparatus has at least one traffic direction display for displaying a traffic direction specified by the route guidance.

30. A system for carrying out the method according to claim 20, the system comprising:
a sensor apparatus for determining an actual state of occupancy of at least one passenger seat of a vehicle;
an information acquisition device for determining information associated with a state of occupancy of the at least one passenger seat;
at least one memory for storing the actual state of occupancy and for storing the associated information;
a data processing apparatus adapted to determine prediction data relating to a future state of occupancy of the passenger seat based on the actual state of occupancy and the associated information; and
an output apparatus being linked with said data processing apparatus or said at least one memory for a transmission of data.

31. The system according to claim 30, wherein said data processing apparatus is adapted to determine a route guidance for passengers based on the prediction data.

32. The system according to claim 30, wherein said output apparatus is adapted to output at least one of the prediction data or the route guidance at least one of visually, haptically or acoustically.

33. The system according to claim 30, wherein said output apparatus has at least one traffic direction display for displaying a traffic direction specified by the route guidance.

34. A non-transitory computer program product for predicting a state of occupancy of a passenger seat, comprising instructions stored thereon, that when executed on a processor, cause the system according to claim 26 to carry out a method for predicting a future state of occupancy of a passenger seat, including:
determining an actual state of occupancy of the passenger seat by using sensors;
acquiring information associated with the future state of occupancy of the passenger seat;
determining prediction data relating to the future state of occupancy of the passenger seat based on the actual state of occupancy and the associated information by using a data processing apparatus; and
outputting the prediction data to passengers by using an output apparatus.

35. A non-transitory computer program product for predicting a state of occupancy of a passenger seat, comprising instructions stored thereon, that when executed on a processor, cause the system according to claim 30 to carry out a method for traffic management of passengers, including:
determining the prediction data for a plurality of passenger seats in the vehicle;
determining a route guidance for passengers based on the prediction data; and
outputting the route guidance to passengers by using an output apparatus.
